(19) United States
(12) Patent Application Publication
(10) Pub. No.: US 2002/0085014 A1
(43) Pub. Date: Jul. 4, 2002

(54) Rendering device

(76) Inventors: Masato Yuda, Osaka (JP); Shigeo Asahara, Ikeda (JP); Kenji Nishimura, Nabari (JP); Hitoshi Araki, Yawata (JP); Keiichi Senda, Takaraduka (JP)

Correspondence Address: WENDEROTH, LIND & PONACK, L.L.P., 2033 K STREET N. W., SUITE 800, WASHINGTON, DC, 20006-1021, US

(21) Appl. No.: 10/026,525

(22) Filed: Dec. 27, 2001

(30) Foreign Application Priority Data
Dec. 28, 2000 (JP) 2000-402384

(51) Int. Cl. G09G 5/00

(52) U.S. Cl. 345/582

(57) ABSTRACT

In a rendering device Urend1, a processor 1 receives object data Dpol which defines a polygon by shape, and object data Dlin which defines a line by shape. The processor 1 also receives mesh data Dms which specifies a three-dimensional mesh representing a shape of a ground surface. Based on thus received object data Dpol and the mesh data Dms, the processor 1 generates intermediate data Dlm3 which represents the polygon mapped onto the three-dimensional mesh. Further, based on the received object data Dlin and the mesh data Dms, the processor 1 draws the shape of the line on the three-dimensional mesh so that display image data Ddisp which can display a three-dimensional image including the polygon and line drawn on the ground surface is generated. In this manner, realized is the rendering device Urend1 capable of generating the display image data having no deformation on lines when displayed.

### BACKGROUND OF THE INVENTION

1. Field of the Invention

The present invention relates to rendering devices and, more specifically, to rendering devices for generating display image data which represents three-dimensional images including polygons and lines.

2. Description of the Background Art

The above type of rendering devices have been often applied to navigation devices and game machines. As an example, described below is the navigation device which has been disclosed in U.S. Pat. No. 5913918. In this navigation device, a map searching unit reads cartographic data of a predetermined range from a map storing unit. A processor then subjects four vertices of thus read cartographic data to perspective transformation based on eye point and focus point coordinates inputted from an input unit. The resultant coordinates are mapped onto the cartographic data, and displayed on an output unit is a three-dimensional (3D) map derived thereby.

Thus displayed 3D map represents, generally, polygonal objects typified by buildings and city blocks, and linear objects typified by roads and railroads. Such linear objects show a conspicuous difference from the polygonal objects in width. However, in spite of such a difference, the above navigation device applies the same process to the polygons and lines to map those onto the ground surface. As a result, there arises a problem that lines in the resultant 3D map which are supposed to be uniform in width appear thick in some parts, and thin in some other parts. Such a problem is not familiar only to this navigation device but also to devices which generate display image data by mapping both the polygons and lines.

### SUMMARY OF THE INVENTION

Therefore, an object of the present invention is to provide rendering devices capable of generating display image data without deforming lines when displayed.

The present invention has the following features to attain the object above.

An aspect of the present invention is directed to a device for rendering a polygon and a line. The rendering device comprises an object reception section for receiving object data which defines the polygon or the line by shape, a mesh reception section for receiving mesh data which represents a shape of a surface onto which the polygon and the line are drawn, and a rendering processing section. The rendering processing section uses the object data defining the polygon received by the object reception section and the mesh data received by the mesh reception section to map the polygon onto the surface, and to draw the line on the surface, uses the object data defining the line received by the object reception section and the mesh data received by the mesh reception section.

Mapping narrow lines onto the surface results in conspicuous deformation. Therefore, in the present invention, the rendering processing section uses the object data defining the corresponding line to directly render the line on the surface. As a result, the rendering processing section becomes capable of generating display image data without deforming lines when displayed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a rendering device Urend1 according to a first embodiment of the present invention;

FIG. 2 is a diagram showing temporary storage areas 31 to 34 which are reserved in a working area 3 of FIG. 1;

FIG. 3 is a diagram showing a mesh database DEmesh and an object database DBobj which are stored in a storage device Ustor of FIG. 1;

FIG. 4A is a schematic diagram showing a three-dimensional (3D) mesh MS represented by the mesh database DBmesh of FIG. 3;

FIG. 4B is a schematic diagram showing the data structure of the mesh database DBmesh of FIG. 3;

FIG. 5A is a schematic diagram showing the data structure of the object database DBobj of FIG. 3;

FIG. 5B is a schematic diagram showing the detailed data structure of each of object data Dpol1 to Dpoln of FIG. 5A;

FIG. 5C is a schematic diagram showing an exemplary polygon PL represented by any of the object data Dpol1 to Dpoln of FIG. 5A;

FIG. 6A is a schematic diagram showing the detailed data structure of each of object data Dlin1 to Dlini of FIG. 5A;

FIG. 6B is a schematic diagram showing an exemplary line Ln represented by any of the object data Dlin1 to Dlini of FIG. 5A;

FIG. 7 is a flowchart showing the first half of the procedure of a processor 1 written in a computer program 21 of FIG. 1;

FIG. 8 is a flowchart showing the second half of the procedure of the processor 1 to be executed after the procedure of FIG. 7;

FIG. 9A is a schematic diagram showing a 3D mesh MS represented by mesh data Dms to be transferred in step S31 of FIG. 7;

FIG. 9B is a schematic diagram showing an image representing intermediate image data Dim1 to be generated in step S37 of FIG. 7;

FIG. 10A is a schematic diagram showing an image representing a 3D mesh MS′ to be rendered in step S40 of FIG. 8;

FIG. 10B is a schematic diagram showing an image represented by intermediate data Dim3 to be generated in step S41 of FIG. 8;

FIG. 11A is a schematic diagram showing the process in step S46 of FIG. 8;

FIG. 11B is a schematic diagram showing an image represented by intermediate image data Dim4 to be generated in step S47 of FIG. 8;

FIG. 12 is a block diagram showing the structure of a rendering device Urend2 according to a second embodiment of the present invention;

FIG. 13 is a diagram showing the temporary storage areas 31 to 34 which are reserved in the working area 3 of FIG. 12;

FIG. 14A is a diagram showing a mesh database DBmesh, an object database DBobj, and a two-dimensional image database DB2dpi which are stored in the storage device Ustor of FIG. 12;

FIG. 14B is a schematic diagram showing the data structure of the two-dimensional image database DB2dpi of FIG. 14A;

FIG. 14C is a schematic diagram showing the detailed data structure of each of two-dimensional image data D2dpi1 to D2dpim of FIG. 14B;

FIG. 15 is a flowchart showing the first half of the

procedure of the processor 1 written in a computer program 22 of FIG. 12;

FIG. 16 is a flowchart showing the detailed procedure of step S52 of FIG. 15; and

FIG. 17 is a schematic diagram showing an image represented by merged image data Dbrd to be generated in step S52 of FIG. 15.

### DESCRIPTION OF THE PREFERRED EMBODIMENTS

FIG. 1 is a block diagram showing the structure of a terminal device Dterm1 into which a rendering device Urend1 according to a first embodiment of the present invention is incorporated. The terminal device Dterm1 of FIG. 1 is typically a device exemplified by navigation devices of a vehicle-mounting type and game machines for generating and displaying display image data Ddisp which represents three-dimensional (3D) images (typically 3D maps) showing polygons having lines drawn thereon. Here, the terminal device Dterm1 includes the rendering device Urend1, a storage device Ustor and a display Udisp. The rendering device Urend1 is connected to the storage device Ustor and the display Udisp for data communications therewith, and includes a processor 1, a program memory 2, and a working area 3.

The processor 1 is typically composed of a CPU (Central Processing Unit) or an MPU (Micro Processing Unit).

The program memory 2 is typically composed of ROM (Read Only Memory), and stores a computer program 21 for a rendering process.

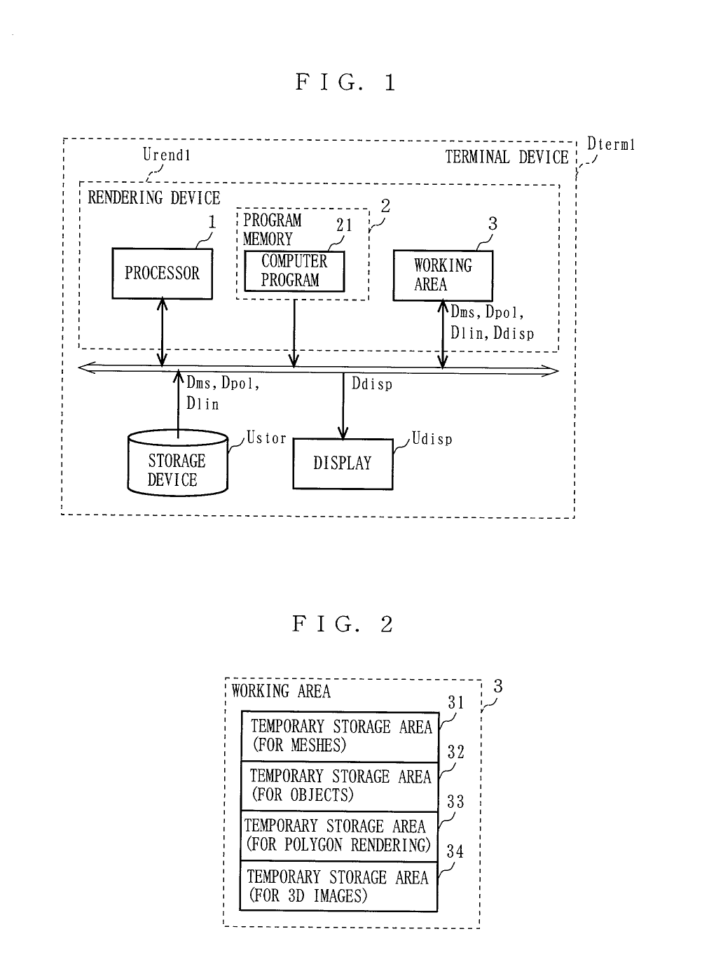

The working area 3 is typically composed of RAM (Random Access memory), and as shown in FIG. 2, has a temporary storage area 31 for meshes, a temporary storage area 32 for objects, a temporary storage area 33 for polygon rendering, and a temporary storage area 34 for 3D images.

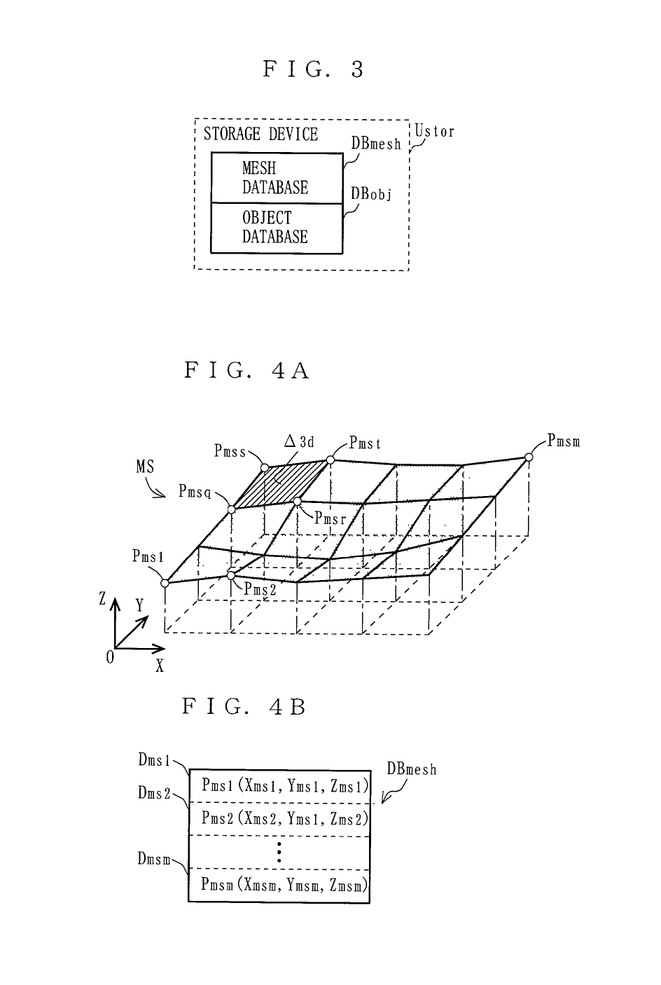

The storage device Ustor is typically composed of a device, exemplified by hard disk drives, compact disk drives, or DVD disk drives, by which at least internally stored data can be read out. The storage device Ustor stores a mesh database DBmesh and an object database DBobj as shown in FIG. 3.

The mesh database DBmesh of FIG. 3 is constructed as below. Referring to FIG. 4A, a topographic map which graphically represents the surface features of a predetermined range is segmented latitudinally (in the X-axis direction) and longitudinally (in the Y-axis direction) each at predetermined intervals. That is, the topographic map is first divided by a two-dimensional (2D) mesh. In the 2D mesh, points of intersection are each specified by the combination of a latitude coordinate value Xms and a longitude coordinate value Yms. The intersection points of the 2D mesh are each additionally assigned with a height value Xms for specifying the topographic features in three dimensions. Formed thereby is a 3D mesh MS including a plurality of intersection points Pms each specified by a set of coordinates (Xms, Yms, Xms) in a 3D space (XYZ orthogonal coordinate system). In the present embodiment, for convenience, the total number of such intersection points Pms is assumed to be m (where m is a natural number), i.e., the intersection points of the 3D mesh MS are Pms1, Pms2, . . . , Pmsm. As shown in FIG. 4B, the mesh database DBmesh includes mesh data Dms1 to Dmsm, each of which is specified by a set of 3D coordinates of the intersection points Pms1 to Pmsm. In the below, as to the 3D mesh MS of FIG. 4A, segment regions each enclosed by line segments connecting four of the intersection points Pms, e.g., intersection points Pmsq, Pmsr, Pmss, and Pmst, are referred to as 3D small blocks Δ3d.

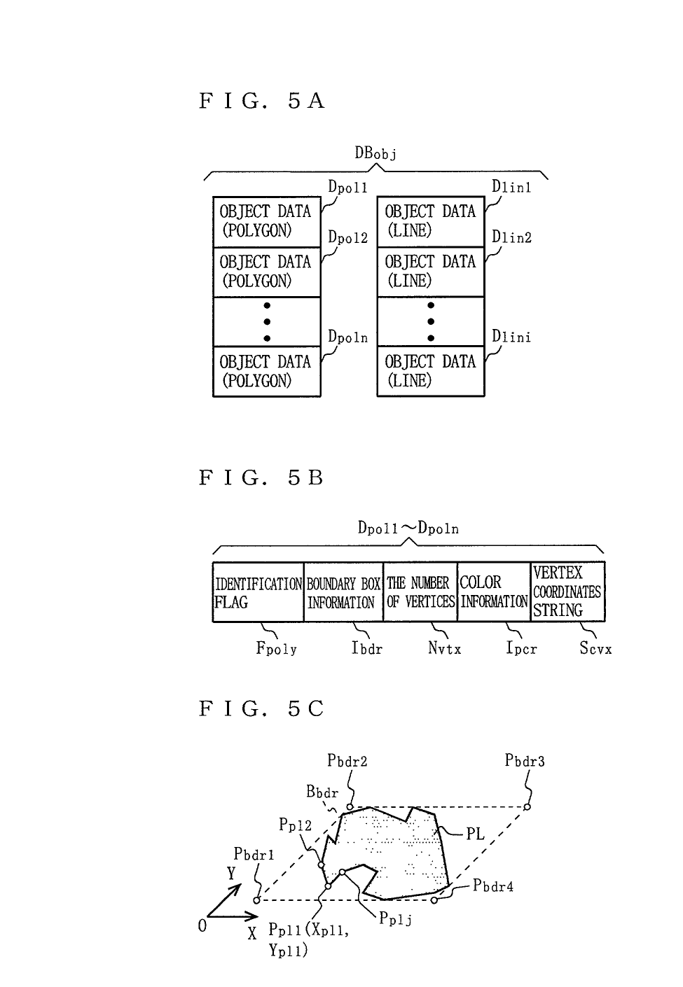

The object database DBobj of FIG. 3 includes, as shown in FIG. 5A, object data Dpol1 to Dpoln, and object data Dlin1 to Dlini. The object data Dpol1 to Dpoln each include, as shown in FIG. 5B, an identification flag Fpoly, boundary box information Ibdr, the number of vertices Nvtx, color information Ipcr, and vertex coordinates string Scvx. Each information in the object data Dpol1 to Dpoln defines various polygons PL by shape on an XY plane.

Here, prior to describing the object data Dpol1 to Dpoln, for convenience, an exemplary polygon PL will be described by referring to FIG. 5C. In FIG. 5C, the polygon PL is on an XY plane, the X axis of which is latitudinally directed, and the Y axis of which is longitudinally directed. The polygon PL is formed by connecting j (where j is a natural number of three or more) pieces of vertices Ppl1 to Pplj in order (shown in FIG. 5C are vertices Ppl1, Ppl2, and Pplj only). The vertices Ppl1 to Pplj are each specified by the combination of a latitude coordinate value Xpl and a longitudinal coordinate value Ypl on the XY plane. As an example, the vertex Ppl1 of FIG. 5C is specified by a set of coordinates (Xpl1, Ypl1). Although not shown, other vertices Ppl2 to Pplj are specified by, respectively, sets of coordinates (Xpl2, Ypl2) to (Xplj, Yplj). Such a polygon PL typically represents a map object such as a block or a building.

Refer back to FIG. 5B. The identification flag Fpoly indicates that the object data Dpol including the flag represents the polygon PL. In this embodiment, for convenience, the identification flag Fpoly is assumed to be 0. The boundary box information Ibdr is not essential to the present invention, and thus will be mentioned briefly later. The number of vertices Nvtx denotes the number of vertices j of the polygon PL. The color information Ipcr specifies what color the polygon PL is to be painted. The vertex coordinates string Scvx is composed of the sets of vertex coordinates (Xpl1, Ypl1) to (Xplj, Yplj) of the polygon PL. It should be noted here that the vertex coordinates string Scvx typically includes those vertex coordinates (Xpl1, Ypl1) to (Xplj, Yplj) in such an order that the polygon PL can be drawn in a stroke.

The boundary box information Ibdr specifies the shape of a boundary box Bbdr of FIG. 5C (a region indicated by the dotted lines). Here, the boundary box Bbdr is typically a rectangle housing the polygon PL therein while abutting to the polygon PL at all sides thereof, and is defined by four sets of XY vertex coordinates of the vertices Pbdr1 to Pbdr4 on the XY plane.

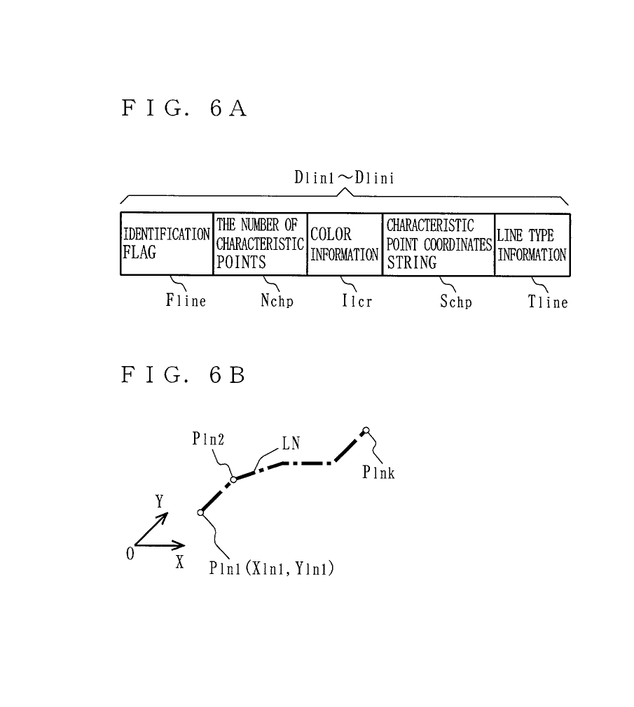

Refer back to FIG. 5A. The object data Dlin1 to Dlini each include, as shown in FIG. 6A, an identification flag Fline, the number of characteristic points Nchp, color information Ilcr, a characteristic point coordinates string Schp, and line information Tline. Each information in the object data Dpol1 to Dpoln defines various linear objects (hereinafter, simply referred to as lines) LN by shape on the XY space.

Prior to describing the object data Dlin1 to Dlini, for convenience, an exemplary line LN will be described by referring to FIG. 6B. In FIG. 6B, the line LN is on the same XY plane as in the above, and formed by connecting k (where k is a natural number) pieces of characteristic points Pln1 to Plnk in order (shown in FIG. 6B are characteristic points Pln1, Pln2, and Plnj only). The characteristic points Pln1 to Plnk are points needed to define the line LN by shape on the XY plane, and in this embodiment, include at least both endpoints of the line LN and any point thereon at where the line LN bends. The characteristic points Pln1 to Plnk are each specified by the combination of a latitude coordinate value Xln and a longitudinal coordinate value Yln on the XY plane. As an example, the characteristic point Pln1 of FIG. 6B is specified by a set of XY coordinates (Xlm1, Yln1). Although not shown, other characteristic points Pln2 to Plnk are specified by, respectively, sets of coordinates (Xln2, Yln2) to (Xlnk, Ylnk).

The identification flag Fline indicates that the object data Dlin including the flag represents the line LN. In this embodiment, for convenience, the identification flag Fline is assumed to be 1 to be distinguished from the identification flag Fpoly being 0. The number of characteristic points Nchp denotes the total number of the characteristic points Pln1 to Plnk included in the line LN. The color information Ilcr denotes in what color the line LN will be painted. The characteristic point coordinates string Schp is composed of sets of XY coordinates (Xlm1, Yln1) to (Xlnk, Ylnk) of the characteristic points of the line LN. Note that the characteristic point coordinates string Schp typically includes those XY coordinates (Xlm1, Yln1) to (Xlnk, Ylnk) in such an order that the line LN can be drawn in a stroke. The line information Tline at least indicates the line type (e.g., solid line, dotted line) and thickness of the line LN.

In FIG. 1, the display Udisp goes through a display process in accordance with display image data Ddisp which is to be generated on the working area 3 with a rendering process executed. The display Udisp then displays the resultant 3D image (3D map in this embodiment) on its screen. Here, the rendering process will be left for later description.

In the terminal device Dterm1 with such a structure, the processor 1 follows the computer program 21 to generate display image data Ddisp on the working area 3 by using the mesh data Dms, and the object data Dpol and Dlin in the storage device Ustor. In the below, the operation of the terminal device Dterm1 is described in more detail while focusing on the operation of the rendering device Urend1.

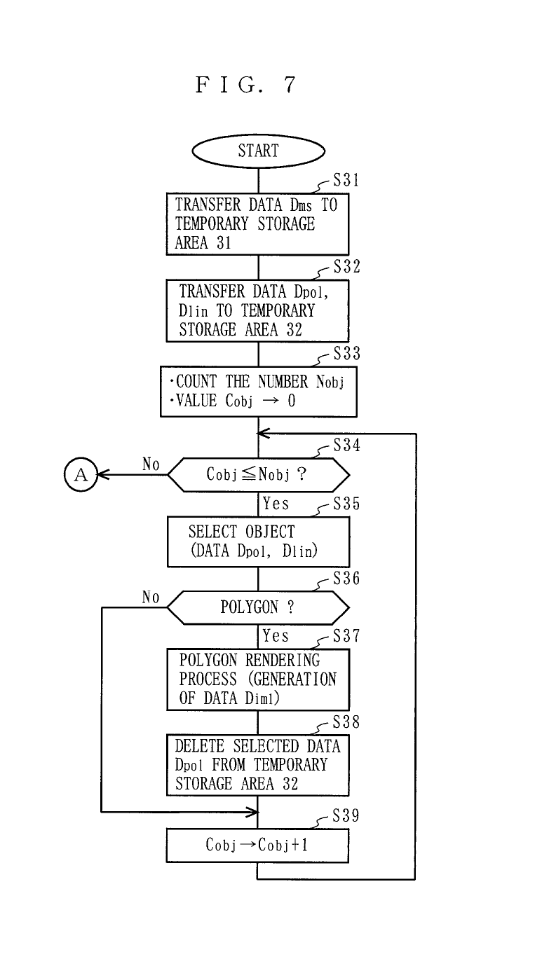

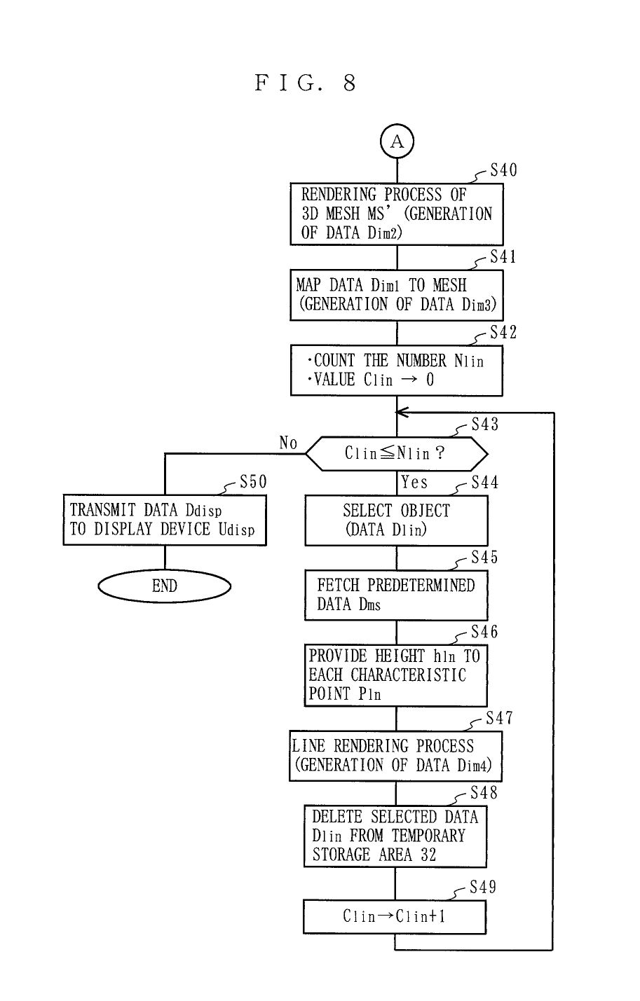

FIGS. 7 and 8 are main flowcharts showing the procedure of the processor 1 written in the computer program 21. In FIG. 7, immediately after starting the computer program 21 for execution, the processor 1 transfers the mesh data Dms of a predetermined region β1 from the storage device Ustor to the temporary storage area 31 (step S31).

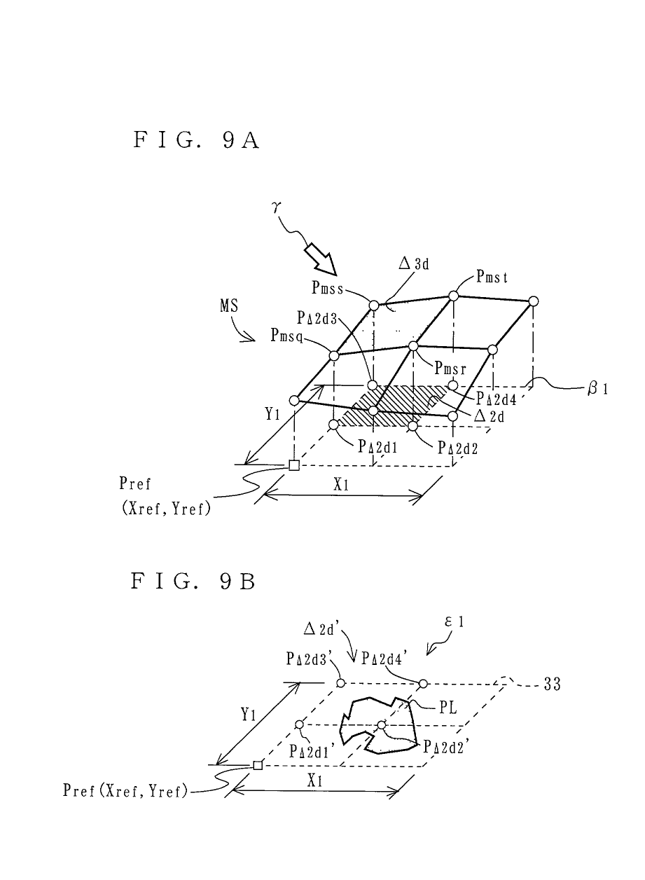

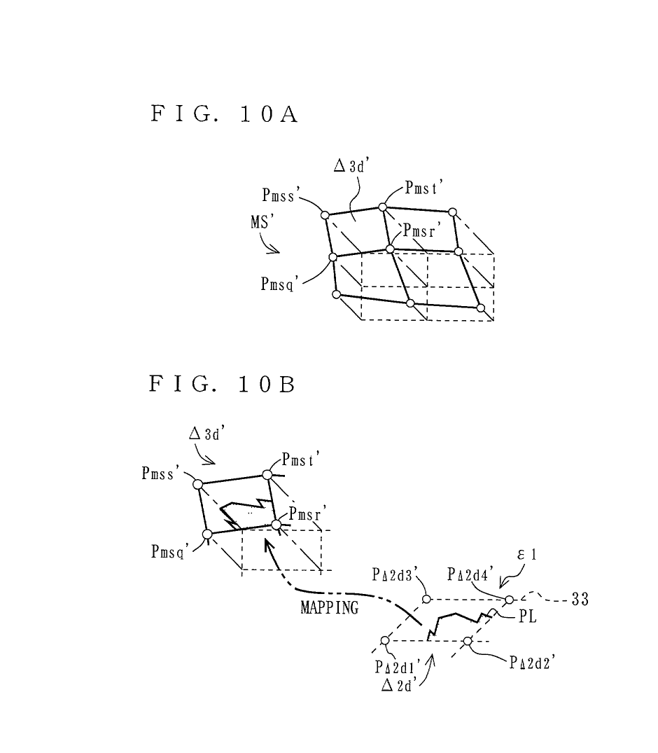

The region β1 is exemplarily a region enclosed by the dotted edges in FIG. 9A. In detail, a reference point Pref (Xref, Yref) is predetermined on the XY plane. The reference point Pref is a point designated by the user of the terminal device Dterm1 or a point derived through calculation made by the processor 1. From the reference point Pref (Xref, Yref), the length of the region β1 in the latitude direction (X-axis direction) is previously set to X1, and in the longitude direction (Y-axis direction) to Y1. The mesh data Dms of the region β1 includes XYZ coordinates of a plurality of intersection points, the latitude coordinate value Xms of which is in the range from Xref to Xref+X1, and the longitude coordinate value Yms from Yref to Yref+Y1. In the present embodiment, for convenience, such a region β1 is supposed to be also a range of the 3D map displayed on the display Udisp.

For the sake of simplification, the mesh data Dms of the region β1 is presumed to be transferred in step S31. Alternatively, with the aim of displaying the 3D map at higher speed, in step S31, the mesh data Dms of the region bigger than the region β1 may be transferred to the temporary storage area 31 which is composed of RAM shorter in access time than the storage device Ustor.

The processor 1 then transfers the object data Dpol and Dlin of the region β1 from the storage device Ustor to the temporary storage area 32 (step S32). This is merely for the sake of simplification, and transferred here may be the object data Dpol and Dlin of the region bigger than the region β1.

After step S32, the processor 1 counts and retains the total number Nobj of the object data Dpol and Dlin in the temporary storage area 32, and then sets a value Cobj of a counter (not shown) to an initial value 0 (step S33). Here, in step S35 which will be described later, one object data is selected out of those Dpol and Dlin in the temporary storage area 32. The counter value Cobj indicates how many of the object data Dpol and Dlin have been selected in step S35.

It should be noted here that the order of steps S31, S32, and S33 is not restrictive as long as step S33 follows step S32.

The processor 1 then determines whether the counter value Cobj is equal to the number Nobj or smaller (step S34). If not Cobj<=Nobj, the processor 1 regards that all of the object data Dpol and Dlin in the temporary storage area 32 have been selected in step S35, and thus the procedure goes to step S40 which will be described later (see FIG. 8). If Cobj<=Nobj, the processor 1 regards that any of the object data Dpol and Dlin is yet left in the temporary storage area 32, and thus the procedure goes to step S35.

The processor 1 selects one object data out of those Dpol and Dlin in the temporary storage area 32 (step S35), and then determines what the object data represents, i.e., the polygon PL or the line LN (step S36). More specifically, to make such a determination, the processor 1 refers to the identification flag Fpoly or Flin (0 or 1) in the selected object data Dpol or Dlin. In this embodiment, when the value is 0, it means that the selected object data is Dpol, and when the value is 1, selected is the object data Dlin.

When the object data Dlin is selected in step S35, the procedure goes to step S39, which will be described later. On the other hand, when selected in step S35 is the object data Dpol, the processor 1 performs a polygon rendering process (step S37). At this time, represented in the temporary storage area 33 is the XY plane specified by the region β1, and the processor 1 generates intermediate image data Dim1 on the temporary storage area 33 (step S37). As shown in FIG. 9B, the intermediate image data Dim1 is a bit image ε1 which represents the polygon PL. The processor 1 then adds, if necessary, the values of the reference point Pref (Xref, Yref), the length X1, and the length Y1 to the intermediate image data Diml1.

Next, the processor 1 deletes the object data Dpol selected in step S35 from the temporary storage area 32 (step S38), and then increments the counter value Cobj by 1 (step S39). The procedure then returns to step S34.

The processor 1 repeats the processes of steps S34 to S39 so that only the object data Dpol in the temporary storage area 32 is subjected to the rendering process. After completion of the rendering process, the intermediate image data Dim1 being the bit image ε1 representing the polygon PL is generated on the temporary storage area 33 (step S37). In this manner, at the time when Cobj<=Nobj is determined as not being satisfied in step S34, generated on the temporary storage area 33 is the intermediate image data Dim1 being the bit image ε1 representing every polygon PL for the region β1. Moreover, at this point in time, the temporary storage area 32 has no object data Dpol and therein, only the object data Dlin is left.

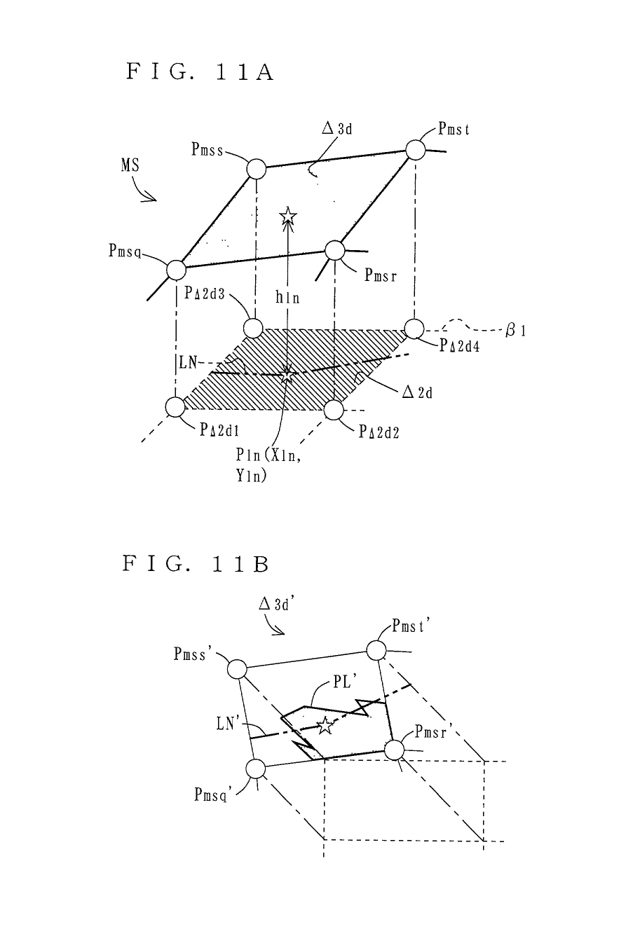

If Cobj<=Nobj is determined as not being satisfied in step S34, the processor 1 performs a mesh rendering process with the mesh data Dms transferred to the temporary storage area 31 in step S31 (FIG. 8; step S40). At this time, the processor 1 applies a perspective transformation process to the mesh data Dms, and thereby, intermediate image data Dim2 is generated on the temporary storage area 34 as shown in FIG. 10A. The intermediate image data Dim2 is the one representing a 3D mesh MS', which is the one viewing the 3D mesh MS from a predetermined viewpoint (or a view reference point) Υ (see FIG. 9A). The 3D mesh MS′ is structured by a plurality of 3D small blocks Δ3d′, which are the ones viewing the 3D small blocks Δ3d of the 3D mesh MS from the viewpoint Υ. FIG. 10A shows an example of the 3D small blocks Δ3d′ formed by four vertices Pmsq′ to Pmst′, and some other 3D small blocks Δ3d′ in the vicinity thereof. That is, FIG. 10A shows the result of perspective transformation applied to the 3D small block Δ3d formed by four vertices Pmsq to Pmst, and some other 3D small blocks Δ3d in the vicinity thereof.

The processor 1 then performs a mapping process typified by texture mapping with the intermediate image data Dim1 in the temporary storage area 33 and the intermediate image data Dim2 in the temporary storage area 34 (step S41). In detail, in step S41, the processor 1 calculates 2D small blocks Δ2d from the mesh data Dms in the temporary storage area 31, more specifically, from the set of vertex coordinates (Xms, Yms, Xms) of the respective 3D small blocks Δ3d of the 3D mesh MS. As an example, assuming here that the 3D small block Δ3d indicated by dots in FIG. 9A is formed by four vertices of Pmsq(Xmsq, Ymsq, Xmsq), Pmsr(Xmsr, Ymsq, Xmsr), Pmss(Xmsq, Ymss, Zmss), and Pmst(Xmsr, Ymss, Xmst). Under this assumption, the processor 1 replaces the Z component values (the height values) of the vertices Pmsq to Pmst with 0, and thereby, derives a 2D small block Δ2d (a part indicated by slashes) which is formed by four vertices PΔ2d1 to PΔ2d4 and by projecting the 3D small block Δ3d onto the XY plane. Here, the vertex PΔ2d1 has the XY coordinates of (Xmsq, Ymsq), the vertex PΔ2d2 of (Xmsr, Ymsq), the vertex P Δ2d3 of (Xmsq, Ymss), and the vertex PΔ2d4 of (Xmsr, Ymss).

Then. the processor 1 derives a predetermined region Δ2d′ from those XY coordinates of the vertices PΔ2d1 to PΔ2d4. Here, the predetermined region Δ2d′ is a region corresponding to the 2D small block Δ2d in the bit image ε1 (see FIG. 9B). Assuming here that four vertices PΔ2d1′, PΔ2d2′, PΔ2d3′, and P Δ2d4′ specifying the predetermined region Δ2d′ have the XY coordinates, respectively, (Xmsq″, Ymsq″), (Xmsr″, Ymsq″), (Xmsq″, Ymss″), and (Xmsr″, Ymss″). Under this assumption, satisfied are Xmsq″=Xmsq−Xref, Ymsq″=Ymsq−Yref, Xmsr″=Xmsr−Xref, and Ymss″=Ymss−Yref.

The processor 1 then maps, in the intermediate image data Dim1, any part of the bit image ε1 corresponding to thus derived region Δ2d′ onto the 3D small block Δ3d of the 3D mesh MS′ derived in step S40. For example, the 3D mesh MS′ of FIG. 10A includes the 3D small block Δ3d′. As described in the above, the 3D small block Δ3d′ is the one derived by subjecting the 3D small block Δ3d formed by four vertices Pmsq to Pmst to perspective transformation. The vertices Pmsq′ to Pmst′ of the 3D small block Δ3d′ correspond to the vertices PΔ2d1′ to PΔ2d4′ of the predetermined region Δ2d′. Thus, as shown in FIG. 10B, the processor 1 maps any part of the bit image ε1 corresponding to the region Δ2d′ onto the 3D small block Δ3d in such a manner that the vertices PΔ2d1′ to PΔ2d4′ correspond to the vertices Pmsq′ to Pmst′.

The processor 1 applies such a mapping process to every 3D small block Δ3d′ of the 3D mesh MS′. As a result, intermediate image data Dim3 representing a 3D image of the polygon PL mapped onto the 3D mesh MS′ is generated on the temporary storage area 34. In the below, the polygon PL mapped onto the 3D mesh MS′ is referred to as a polygon PL′.

The processor 1 then counts and retains the total number Nlin of the object data Dlin in the temporary storage area 32, and sets a value Clin of a counter (not shown) to an initial value 0 (step S42). Here, the counter value Clin indicates how many of the object data Dlin have been selected in step S44, which will be described later.

Then, the processor 1 determined whether the counter value Clin is equal to the number Nlin or smaller (step S43). If not Clin<=Nlin, the processor 1 regards that all of the object data Dlin in the temporary storage area 32 have been selected in step S44 so that the procedure goes to step S50, which will be described later. On the other hand, if Clin<=Nlin, the processor 1 regards that any of the object data Dlin in the temporary storage area 32 is not yet selected so that the procedure goes to step S44.

The processor 1 selects one of the object data Dlin in the temporary storage area 32 (step S44), and then fetches the mesh data Dms satisfying a predetermined condition from the temporary storage area 31 (step S45). In step S45, from the characteristic point coordinates string Schp of the object data Dlin selected in step S44, the processor 1 derives minimum and maximum coordinate values Xmin and Xmax in the Latitude direction (X-axis direction), and minimum and maximum coordinate values Ymin and Ymax in the longitude direction (Y-axis direction). The processor 1 then fetches the mesh data Dms of a rectangle region defined by sets of coordinates (Xmin, Ymin), and (Xmax, Ymax) from the temporary storage area 31.

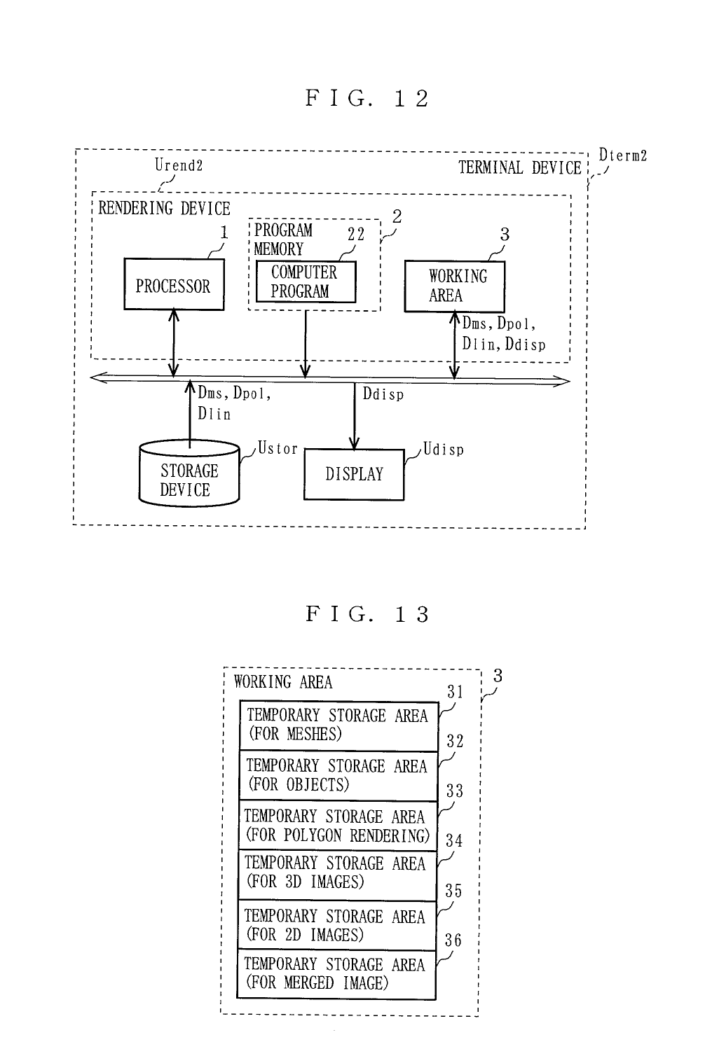

With the mesh data Dms received in step S45, the processor 1 to provide each of the characteristic points Pln of the object data Dlin selected in step S44 with a height value hln (step S46). In the below, a specific exemplary method of calculating the height value hln is described by referring to FIG. 11A. As shown in FIG. 11A, the object data Dlin selected in step S44 includes a characteristic point Pln having the 2D coordinates of (Xln, Yln). For convenience, the characteristic point Pln is assumed to be included in the 2D small block Δ2d shown in FIG. 9A. The 3D small block Δ3d corresponding to the 2D small block Δ2d is formed by four vertices of Pmsq(Xmsq, Ymsq, Zmsq), Pmsr(Xmsr, Ymsq, Zmsr), Pmss(Xmsq, Ymss, Zmss), and Pmst(Xmsr, YMss, Zmst).

Under this assumption, the height value hln provided to the characteristic point Pln is calculated as follows. First, express h′ and h″ by the following equations (1) and (2).

h′=(Zmsr−Zmsq)×(X1n−Xmsq)/(Xmsr−Xmsq)+Zmsq (1)

h″=(Xmst−Zmss)×(X1n−Xmsp)/(Xmsr−Xmsq)+Zmss (2)

The height value hln is expressed by the following equation (3) by using those h′ and h″ of the equations (1) and (2).

hln=(h″-h′)×(Yln−Ymsq)/(Ymss−Ymsq)+h′ (3)

The processor 1 provides the height value hln calculated in the same manner as above also to other characteristic points Pln. By going through step S46 as such, the processor 1 derives the 3D coordinates (Xln1, Yln1, hln1), (Xln2, Yln2, hln2), . . . , (Xlnk, Ylnk, hlnk) cf the object data Dlin, that is, the characteristic points Pln1 to Plnk of the line Ln .

Based on the 3D coordinates Pln1(Xln1, Yln1, hln1) to Plnk(Xlnk, Ylnk, hlnk) of the line LN, and the color information Ilcr and the line type information Tline of the object data Dlin, the processor 1 applies the rendering process to the line LN on the temporary storage area 34 (step S47). To be more specific, on the temporary storage area 34, the processor 1 connects those 3D coordinates Pln1 to Plnk in order by using the color indicated by the color information Ilcr, and the thickness, and the line type indicated by the line type information Tline.

Here, prior to connecting the 3D coordinates Pln1 to Pink in order, the processor 1 may add a predetermined correction value Δh to the height value hln calculated for each of the characteristic points Pln in accordance with the equation (3). By going through such a rendering process, the line LN embosses on the surface of the 3D mesh MS′.

Also, simply connecting the 3D coordinates Pln1 to Plnk as in the above may not successfully draw the line LN along the surface of the 3D mesh MS′. Thus, it is more referable for the processor 1 to go through a process to help the line LN to go along the surface of the 3D mesh MS′. Herein, however, such a process of making the line LN along the surface of the line LN is not the purpose of the present invention, and thus is not described in detail.

In step S47, the processor 1 applies the perspective transformation process to those 3D coordinates Pln1(Xlm1, Yln1, hln1) to Plnk(Xlnk, Ylnk, hlnk) of the line LN, and derived thereby is a line LN′ which is the one viewing the line LN from the same viewpoint Υ as above. The processor 1 thus generates, on the temporary storage area 34, intermediate image data Dim4 representing a 3D image in which the line LN′ is drawn on the polygon PL′ mapped onto the 3D small block Δ3d′ (see FIG. 11B). In the present embodiment, the intermediate image data Dim4 represents the 3D map of the region β1 including the polygon(s) PL′ (blocks, buildings), and the line(s) LN′ (roads, railroads) selected in step S44 rendered on the 3D mesh MS′ (ground surface).

The processor 1 then deletes the object data Dlin selected in step S44 from the temporary storage area 32 (step S48), and then increments the counter value Clin by 1 (step S49). The procedure then returns to step S43.

The processor 1 repeats the processes of steps S43 to S49 so that only the object data Dlin in the temporary storage area 32 is subjected to the rendering process. As a result of completing the rendering process, display image data Ddisp is generated in the temporary storage area 34 (step S47). Accordingly, at the point in time when Clin<=Nlin is determined as not being satisfied in step S43, the display image data Ddisp which represents the complete 3D map having every line LN rendered thereon is generated on the temporary storage area 34. In this embodiment, the display image data Ddisp represents the 3D map of the region β1 showing the polygon (s) PL′ (blocks, buildings), and line(s) LN′ (roads, railroads) rendered on the 3D mesh MS′ (ground surface). At this point, every object data Dlin has been deleted from the temporary storage area 32.

If Clin<=Nlin is determined as not being satisfied in step S43, the processor 1 transfers the display image data Ddisp currently in the temporary storage area 34 to the display Udisp (step S50). The display device Udisp performs a display process according to thus received display image data Ddisp, and then displays the resultant 3D image (3D map in this embodiment) on its screen.

As such, the rendering device Urend1 does not draw a 3D polygon PL directly from the object data Dpol, but prior to rendering the 3D polygon PL, first generates a 2D bit image on the temporary storage area 33 for mapping onto the 3D mesh MS′. To draw a line LN, the rendering device Urend1 first provides a height value hln to each of the characteristic points Pln of the object data Dlin. Then, according to the line type information Tline and the color information Ilcr, the rendering device Urend1 draws the line LN directly onto the 3D mesh MS′ on which the polygons PL has been drawn.

The reason why differing the rendering process between the polygon PL and the line LN is due to the difference therebetween in width. That is, the polygon PL is wider than the line LN. Thus, mapping the polygon PL onto the 3D mesh MS′ merely results in relatively inconspicuous deformation occurring to the resultant polygon PL′. However, mapping the line LN onto the 3D mesh MS′ causes the resultant line LN′ to be noticeably deformed, some part of which may be deformed to a considerable extent than the rest. From this point of view, the rendering device Urend1 does not map the line LN onto the 3D mesh MS′, but draws the line LN by connecting in order the characteristic points Pln1 to Plnk represented by the 3D coordinates according to the thickness indicated by the line type information Tline. In this manner, the line LN is successfully prevented from being deformed, and the resultant display image data Ddisp generated by the terminal device Dterm1 can represent the 3D map in which the line LN looks more realistic.

Moreover, by differing the rendering process between the polygon PL and the line LN, other technical effects are to be produced. For example, the polygon PL as a map component (block or building) is often complex in shape with the large number Nvtx of vertices. In such a case, if the polygon PL is directly rendered three dimensionally based on the object data Dpol without applying a mapping process thereto, coordinate transformation has to be carried out for a number of times, putting the load on the processor 1 for processing as such. From such a point of view, in the rendering device Urend1, the processor 1 generates 2D bit image ε1 from the object data Dpol, and then maps the bit image onto the 3D mesh MS′. In this manner, the processor 1 is reduced in processing load.

In the above embodiment, a 3D small block Δ3d of the 3D mesh MS is presumably specified by four intersection points. The number of intersection points is not restrictive, and three or more intersection points may specify the 3D small block Δ3d.

Also in the above embodiment, the processor 1 is presumed to render the polygons PL representing blocks, and the lines LN representing roads, for example. Not only those, the 3D map carries names of landmarks, area names, and the like. Accordingly, the terminal device Dterm1 may store character data representing letters typified thereby in the storage device Ustor, and the resultant display image data Ddisp may represent the 3D map of the region β1 including not only the polygons PL (blocks, buildings) and the lines LN (roads, railroads) rendered on the 3D mesh MS′ but also the letters merged thereon. As a result, the 3D map represented by such display image data Ddisp will be easier to understand for the user. Here, for better viewability of the 3D map, it is preferable for the processor 1 not to apply the coordinate transformation process to the character data, and simply merge the letters onto each appropriate position on the 3D map.

Further, the processor 1 is presumed to transfer the generated display image data Ddisp to the display Udisp in the above. The processor 1 may also save the display image data Ddisp not in the temporary storage areas 31 to 34 but in any other temporary storage area reserved on the working area 3. By doing so, even if the display image data Ddisp is in need later for some reasons, the processor 1 has no need to repeat the procedure of FIGS. 7 and 8 again, but only accessing the storage area on the working area 3 will derive the display image data Ddisp.

In the first embodiment, for the sake of clarity, the terminal device Dterm1 is presumed to display the 3D maps. However, not only to the 3D maps, the terminal device Dterm1 is easily applicable to the rendering process applied to 3D objects typified by buildings, people, and animals, for example. Specifically, the mesh data Dms specifies the topographic features of a 3D object, the object data Dpol two dimensionally defines, by shape, a polygon to be mapped onto the surface of the 3D object, and the object data Dlin two dimensionally defines, by shape, a line to be rendered on the 3D object. On the basis of the mesh data Dms, and the object data Dpol and Dlin as such, the rendering device Urend1 generates the display image data Ddisp in accordance with the procedure of FIGS. 7 and 8.

In the first embodiment, the processor 1 is presumed to transfer the mesh data Dms, and the object data Dpol and Dlin from the storage device Ustor in the terminal device Dterm1 to the working area 3. Here, the mesh data Dms, and the object data Dpol and Dlin may be previously stored in a server located far from the rendering device Urend1 through a network typified by the Internet or LAN (Local Area Network). If this is the case, after receiving the mesh data Dms, and the object data Dpol and Dlin from the server through the network, the rendering device Urend1 generates the display image data Ddisp in accordance with the procedure of FIGS. 7 and 8. As is evident from the above, the rendering device Urend1 does not necessarily include the storage device Ustor.

Further, in the first embodiment, the processor 1 is presumed to transfer the display image data Ddisp to the display Udisp in the terminal device Dterm1. This is not restrictive, and the display image data Ddisp may be transferred from the rendering device Urend1 to a display located far therefrom through the network as above. That is, the rendering device Urend1 does not necessarily include the display Udisp.

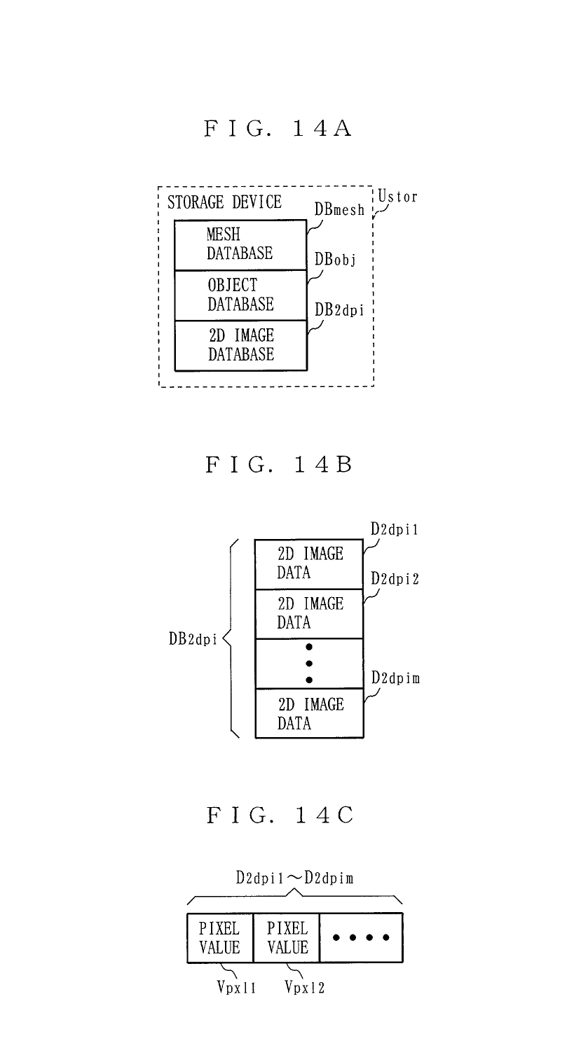

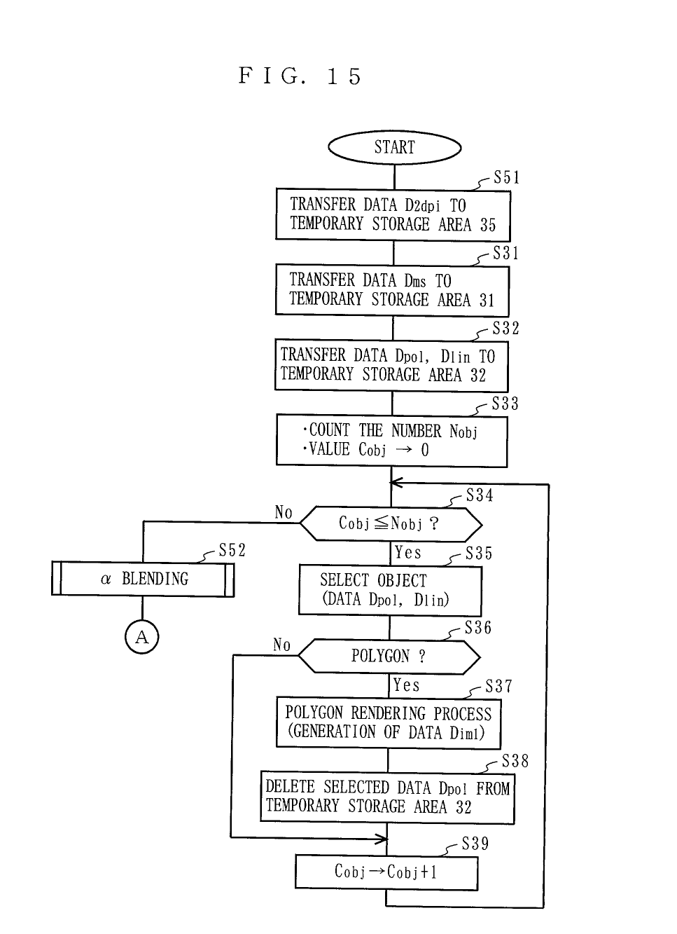

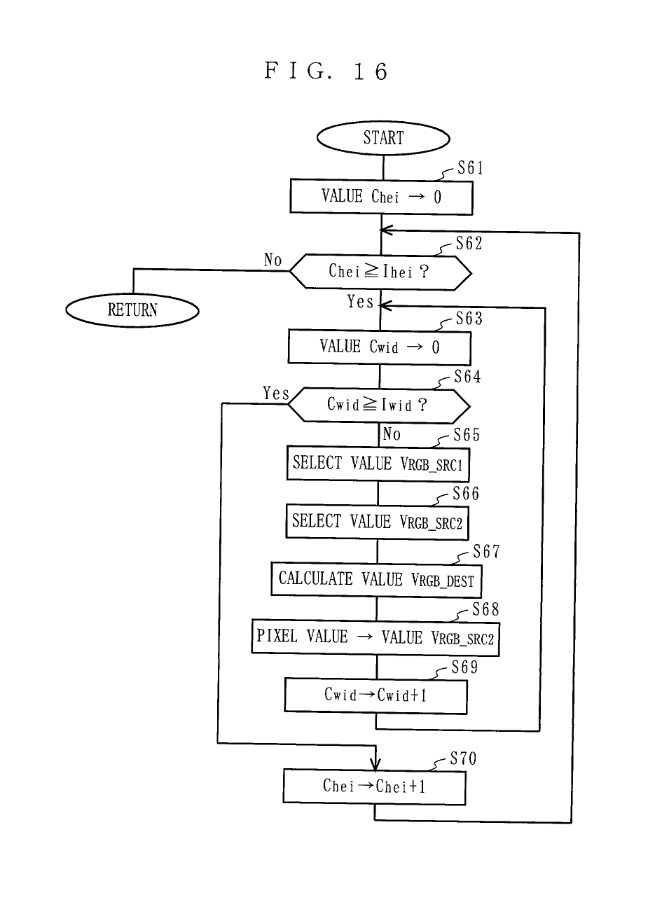

FIG. 12 is a block diagram showing the structure of a terminal device Dterm2 into which a rendering device Urend2 according to a second embodiment of the present invention is incorporated. The terminal device Dterm2 of FIG. 12 is different from the terminal device Dterm1 of FIG. 1 in the following three respects: the working area 3 including a temporary storage area 35 for 2D images and a temporary storage area 36 for merged images as shown in FIG. 13; the storage device Ustor further storing a 2D image database DB2dpi in addition to the mesh database DBmesh and the object database DBobj as shown in FIG. 14; and the program memory 2 storing a computer program 22 as an alternative to the computer program 21. There are no other structural differences therebetween, and thus in the terminal device Dterm2, any identical constituent to the terminal device Dterm1 is under the same reference numeral, and not described again.

Referring to FIG. 14A, the 2D image database DB2dpi is stored in the storage device Ustor, and constructed as below. First, prepared is, at least, an aerial photo showing, from the above, the ground surface of an area covered by the 3D mesh MS (see the first embodiment). For convenience of the rendering process, this aerial photo is segmented latitudinally (in the X-axis direction) and longitudinally (in the Y-axis direction) each at predetermined intervals, i.e., the aerial photo is divided by the 2D mesh, which is described in the first embodiment. As shown in FIG. 14B, the 2D image database DB2dpi includes m pieces of 2D image data D2dpi each represents an aerial photo corresponding to each segmented region. Here, each of the 2D image data D2pdi is a bit image. As shown in FIG. 14C, in the 2D image data D2pdi, pixel values Vpx11, Vpxl2, . . . , for representing the aerial photos are arranged in order. In this respect, the 2D image data D2dpi has a conspicuous difference from the object data Dpol and Dlin.

In the terminal device Dterm with such a structure, the processor 1 of the rendering device Urend2 executes the rendering process by following the computer program 22, and then generates the display image data Ddisp on the working area 3 based on the mesh data Dms, the object data Dpol and Dlin, and the 2D image data D2dpi in the storage device Ustor. In the below, the operation of the terminal device Dterm2 is described in more detail while focusing on the operation of the rendering device Urend2.

FIG. 15 is a main flowchart showing the first half of the rendering process procedure of the processor 1 written in the computer program 22. Compared with the procedure of FIG. 7, the procedure of FIG. 15 further includes steps S51 and S52. This is the only difference therebetween, and in FIG. 15, any step corresponding to that in FIG. 7 is under the same step number, and not described again. The second half of the procedure of the processor 1 is the same as that of FIG. 8, and thus not shown.

In FIG. 15, immediately after starting the computer program 22 for execution, the processor 1 transfers the 2D image data D2dpi of the predetermined region β1 (see the first embodiment) from the storage device Ustor to the temporary storage area 35 (step S51). For convenience, in this embodiment, step S51 is carried out immediately after the computer program 22 is started. Here, since the 2D image data D2dpi in the temporary storage area 35 is used in step S52, which will be described later, step S51 is not limited when to be carried out as long as before step S52.

After step S51, the processor 1 carries out the processes of steps S31 to S39. Here, as described in the first embodiment, at the time when Cobj<=Nobj is determined as not being satisfied in step S34, the intermediate image data Dim1 is generated on the temporary storage area 33. When Cobj<=Nobj is determined as not being satisfied, on the basis of the intermediate image data Dim1 and the 2D image data D2dpi transferred to the temporary storage area 35 in step S51, the processor 1 performs α-blending (step S52). The processor 1 then generates, on the temporary storage area 36, merged image data Dbrd derived by merging the 2D image of the polygon PL represented by the intermediate image data Dim1 and the aerial photo represented by the 2D image data D2dpi. Here, in the present embodiment, in the intermediate data Dim1 and the 2D image data D2dpi, the number of pixels Ihei in the vertical (longitudinal) direction and the number of pixels Iwid in the horizontal (latitude) direction are presumably adjusted to be the same.

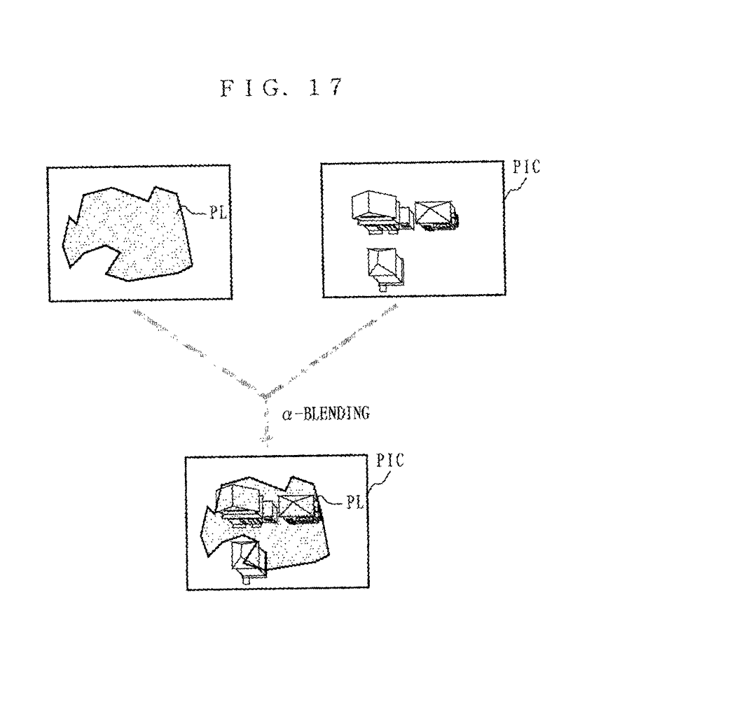

FIG. 16 is a flowchart showing the detailed procedure of step S52. In FIG. 16, the processor 1 sets a value Chei of a counter (not shown) to an initial value 0 (step S61). Here, the counter value Chei indicates a pixel number assigned in ascending order from the reference point Pref in the vertical (longitudinal) direction in the intermediate image data Dim1 and the 2D image data D2dpi.

The processor 1 then determines whether the counter value Chei is equal to the number of pixels Ihei or more (step S62). If Chei >=Ihei, the processor 1 regards that all of the pixels of the intermediate image data Dim1 and the 2D image data D2dpi have been completely processed, and thus ends α-blending (step S52). The procedure then goes to step S40 (see FIG. 8). On the other hand, if not Chel>=Ihei, the processor 1 regards that any of the pixels is yet left for the process, and the procedure then goes to step S63.

The processor 1 then sets a value Cwid of a counter (not shown) to an initial value 0 (step S63). Here, the counter value Cwid indicates a pixel number assigned in ascending order from the reference point Pref in the horizontal (latitude) direction in the intermediate image data Dim1 and the 2D image data D2dpi.

The processor 1 then determines whether the counter value Cwid is equal to the number of pixels Iwid or more (step S64). If Cwid >=Iwid, the processor 1 regards that every pixel in one row of the intermediate image data Dim1 and the 2D image data D2dpi has completely processed, and then the procedure goes to step S70. On the other hand, if not Cwid >=Iwid, the processor 1 regards that any of the pixels is yet left in the row for the process, and then the procedure goes to step S65.

The processor 1 selects, as a value VRGE_SRC1, a pixel value Vpxi which is uniquely specified by the current counter values Chei and Cwid in the 2D image data D2dpi (step S65).

The processor 1 also selects, as a value VRGB_SRC2, a pixel value which is uniquely specified by the current counter values Chei and Cwid in the intermediate image data Dim1 (step S66). Here, step S66 may be carried out before step S65.

The processor 1 then calculates a value VRGB_DEST expressed by the following equation (4) (step S67).

VRGBG_{—}DEST=VRGB_{—}SRC1×α+VRGB_{—}SRC2×(1-α) (4)

Next, in the temporary storage area 36, the processor 1 sets thus calculated value VRGB_DEST in step S67 to the pixel value uniquely specified by the current counter values Chei and Cwid (step S68).

The processor 1 then increments the counter value Cwid by 1 (step S69), and the procedure returns to step S63. By repeating such the processes of steps S64 to S69, the processor 1 sequentially calculates the pixel values for the row of the merged image data Dbrd, and stores those into the temporary storage area 36. In step S64, at the time point when Cwid >=Iwid is determined as being satisfied, the temporary storage area 36 carries all of the pixel values for the row of the merged image data Dbrd.

If determined in step S64 that Cwid >=Iwid is satisfied, the processor 1 increments the counter value Chei by 1 (step S70), and the procedure returns to step S62. By repeating such processes of steps S62 to S70, even after completing the calculation of the pixel values for the row and storing those into the temporary storage area 36, the processor 1 keeps calculating the pixel values for the next row. When Chei>=Ihei is determined as being satisfied in step S62, the temporary storage area 36 carries Ihei×Iwid pieces of the pixel values of the merged image data Dbrd. In such a manner, the processor 1 generates, on the temporary storage area 36, the merged image data Dbrd by merging the polygon PL and an aerial photo PIC as shown in FIG. 17. After α-blending is ended, the procedure goes to step S40 of FIG. 8 and onward.

The process in step S40 and onward is already described in the first embodiment, and no further description is given here. Note that, in step S41 of this embodiment, used as the basis for texture mapping are the merged image data Dbrd in the temporary storage area 36 and the intermediate image data Dim2 in the temporary storage area 34, and generated thereby is the intermediate image Dim3.

As such, the terminal device Dterm2 carries out α-blending based on the intermediate image data Dim1 and the 2D image data D2dpi. Therefore, the 3D map represented by the display image data Ddisp includes not only the polygons PL and lines LN but also the actual aerial photo PIC, which are merged thereonto. In this manner, the 3D map displayed on the display Udisp can be more expressive.

Here, in the above second embodiment, the 2D image data D2dpi representing the aerial photo for the region β1 is transferred to the temporary storage area 35 in step S51. In step S31, the mesh data Dms which specifies the 3D mesh MS of the same region β1 is transferred to the temporary storage area 31. Further, in step S32, the object data Dpo1 and Dlin specifying the polygon(s) PL and line(s) LN for the same region β1 are transferred to the temporary storage area 32. Alternatively, the 2D image data D2dpi representing the aerial photo of a region β2 may be transferred to the temporary storage area 35 in step S51, and the object data Dpol and Dlin specifying other polygon(s) PL and line(s) LN for a region β3 different from the region β1 may be transferred to the temporary storage area 32 in step S32. Here, the regions β2 and β3 are both parts of the region β1, and the regions 2 and β3 form the region β1.

In the second embodiment, in the intermediate data Dim1 and the 2D image data D2dpi, the number of pixels Ihei in the vertical (longitudinal) direction and the number of pixels Iwid in the horizontal (latitude) direction are presumably adjusted to be the same. In the navigation devices of a general type, the 3D map to be displayed can be changed in size responding to the user's request. For such a size change, the processor 1 receives, from an input device which is not shown, the horizontal size XH and the vertical size YV for specifying the user's requesting display size. The processor 1 performs a scaling process in step S37 of FIG. 15 so that the resultant intermediate image data Dim1 has the horizontal size of XH and the vertical size of YV. The processor 1 then adds, to the intermediate image data Dim1, the values of the reference point Pref (Xref, Yref), the lengths X1 and Y1, and the sizes XH and YV. Prior to performing α-blending in step S52 of FIG. 15, the processor 1 calculates a scaling factor Rscale on the basis of the lengths X1 and Y1, and the sizes XH and YV added to the intermediate image data Dim1. Then, using thus calculated scaling factor Rscale, the processor 1 applies the scaling process to the 2D image data D2dpi in the temporary storage area 35 before carrying out α-blending.

In the second embodiment, the 2D image data D2dpi is presumed to represent an aerial photo. However, as is evident from the first embodiment, the terminal device Dterm2 can generate display image data Ddisp representing also the 3D objects other than the 3D maps. Therefore, not only the aerial photo, the 2D image data D2dpi may represent any other images of buildings, people, or animals, for example.

Further, in the second embodiment, the merged image data Dbrd is generated by α-blending, but any other blending processes will generate the merged image data Dbrd.

While the invention has been described in detail, the foregoing description is in all aspects illustrative and not restrictive. It is understood that numerous other modifications and variations can be devised without departing from the scope of the invention.

What is claimed is:

1. A device for rendering a polygon and a line, comprising:
an object reception section for receiving object data which defines said polygon or said line by shape;
a mesh reception section for receiving mesh data which represents a shape of a surface onto which said polygon and said line are drawn; and
a rendering processing section, wherein
said rendering processing section
maps, based on the object data defining the polygon received by said object reception section and the mesh data received by said mesh reception section, the polygon onto said surface,
draws, based on the object data defining the line received by said object reception section and the mesh data received by said mesh reception section, the line onto said surface.

2. The rendering device according to claim 1, wherein
said object data includes an identification flag indicating which of the polygon and the line is defined thereby by shape,
said rendering processing section
determines, based on the identification flag included in the object data received by said object reception section, which of the polygon or the line is defined thereby by shape,
when the object data received by said object reception section is determined as defining the polygon, the polygon is mapped onto a surface represented by the mesh data received by said mesh reception section, and
when the object data received by said object reception section is determined as defining the line, the line is mapped onto the surface represented by the mesh data received by said mesh reception section.

3. The rendering device according to claim 1, wherein
said mesh data specifies a three-dimensional mesh representing a shape of a ground surface which is used as a basis of a three-dimensional map, and
said object data defines a two-dimensional shape of the polygon and the line to be drawn on said ground surface, and the polygon represents at least a building and a block on said three-dimensional map, and the line represents at least a road and a railroad on said three-dimensional map.

4. The rendering device according to claim 1, wherein said rendering processing section further generates display image data representing a three-dimensional map showing a letter merged onto said ground surface.

5. The rendering device according to claim 1, wherein said rendering processing section saves display image data generated thereby to a reserved storage.

6. The rendering device according to claim 1, further comprising an image reception section for receiving two-dimensional image data representing a two-dimensional image, wherein
said rendering processing section
performs a blending process based on the object data defining the polygon received by said object reception section, and the two-dimensional image data received by said image reception section, and generates merged image data representing a merged image of said polygon and said two-dimensional image,
maps said merged image onto said surface based on the merged image data generated thereby and the mesh data received by said mesh reception section, and generates intermediate image data,
based on the object data defining the line received by said object reception section, the mesh data received by said mesh reception section, and the intermediate data generated thereby, draws a three-dimensional shape of the line on the surface onto which said merged image is mapped.

7. The rendering device according to claim 6, wherein when generating said intermediate image, said image processing section maps said polygon onto a first region of said surface, and maps the two-dimensional image onto a second region which is different from the first region.

8. A method for rendering a polygon and a line, comprising:
a mesh receiving step of receiving mesh data which represents a shape of a surface onto which said polygon and said line are drawn;
an object receiving step of receiving object data which defines said polygon or said line by shape;
a mapping step of mapping, based on the object data defining the polygon received in said object receiving step and the mesh data received in said mesh receiving step, the polygon onto said surface, and
a line rendering step of drawing, based on the object data defining the line received in said object receiving step and the mesh data received in said mesh receiving step, the line onto said surface.

9. The rendering method according to claim 8, wherein
said object data includes an identification flag indicating which of the polygon and the line is defined thereby by shape,
a determining step is further included for determining, based on the identification flag included in the object data received in said object receiving step, which of the polygon or the line is defined thereby by shape, and
when the object data received in said object receiving step is determined as defining the polygon, said mapping step maps the polygon onto said surface based on the object data and the mesh data received in said mesh receiving step.

10. The rendering method according to claim 8, wherein
said mesh data specifies a three-dimensional mesh representing a shape of a ground surface which is used as a basis of a three-dimensional map, and
said object data defines a two-dimensional shape of the polygon and the line to be drawn on said ground surface, and the polygon represents at least a building and a block on said three-dimensional map, and the line represents at least a road and a railroad on said three-dimensional map.

11. The rendering method according to claim 8, further comprising:
an image receiving step of receiving two-dimensional image data representing a two-dimensional image; and
a blending step of performing a blending process based on the object data defining the polygon received in said object receiving step and the two-dimensional image data received in said image receiving step, and generating merged image data representing a merged image of said polygon and said two-dimensional image, wherein
said mapping step maps said merged image onto said surface based on the merged image data generated in said blending step and the mesh data received in said mesh receiving step, and generates intermediate image data,
said line rendering step draws, based on the object data defining the line received in said object receiving step, the mesh data received in said mesh receiving step, and the intermediate image data generated in said mapping step, the line on the surface onto which said merged image is mapped.

12. The rendering method according to claim 11, wherein said mapping step maps said polygon onto a first region on said surface, and maps said two-dimensional image onto a second region which is different from the first region.

13. A program for realizing a process of rendering a polygon and a line on a computer device, comprising:
a mesh receiving step of receiving mesh data which represents a shape of a surface onto which said polygon and said line are drawn;
an object receiving step of receiving object data which defines said polygon or said line by shape;
a mapping step of mapping, based on the object data defining the polygon received in said object receiving step and the mesh data received in said mesh receiving step, the polygon onto said surface, and
a line rendering step of drawing, based on the object data defining the line received in said object receiving step and the mesh data received in said mesh receiving step, the line onto said surface.

14. The program according to claim 13, wherein
said object data includes an identification flag indicating which of the polygon and the line is defined thereby by shape,
a determining step is further included for determining, based on the identification flag included in the object data received in said object receiving step, which of the polygon or the line is defined thereby by shape, and
when the object data received in said object receiving step is determined as defining the polygon in said determining step, said mapping step maps the polygon onto said surface based on the object data and the mesh data received in said mesh receiving step.

15. The program according to claim 13, wherein
said mesh data specifies a three-dimensional mesh representing a shape of a ground surface which is used as a basis of a three-dimensional map, and
said object data defines a two-dimensional shape of the polygon and the line to be drawn on said ground surface, and the polygon represents at least a building and a block on said three-dimensional map, and the line represents at least a road and a railroad on said three-dimensional map.

16. The program according to claim 13, further comprising:
an image receiving step of receiving two-dimensional image data representing a two-dimensional image; and
a blending step of performing a blending process based on the object data defining the polygon received in said object receiving step and the two-dimensional image data received in said image receiving step, and generating merged image data representing a merged image of said polygon and said two-dimensional image, wherein
said mapping step maps said merged image onto said surface based on the merged image data generated in said blending step and the mesh data received in said mesh receiving step, and generates intermediate image data,
said line rendering step draws, based on the object data defining the line received in said object receiving step, the mesh data received in said mesh receiving step, and the intermediate image data generated in said mapping step, the line on the surface onto which said merged image is mapped.

17. The program according to claim 16, wherein said mapping step maps said polygon onto a first region on said surface, and maps said two-dimensional image onto a second region which is different from the first region.

18. The program according to claim 13, said program is recorded on a recording medium.
